(19) United States
(12) Patent Application Publication
(10) Pub. No.: US 2007/0075000 A1
(43) Pub. Date: Apr. 5, 2007

(54) Sort mechanism and method of use

(75) Inventors: Scott Martens, Vestal, NY (US); Craig Peron, Apalachin, NY (US)

Correspondence Address: GREENBLUM & BERNSTEIN, P.L.C., 1950 ROLAND CLARKE PLACE, RESTON, VA, 20191, US

(73) Assignee: LOCKHEED MARTIN CORPORATION, Bethesda, MD (US)

(21) Appl. No.: 11/239,125

(22) Filed: Sep. 30, 2005

(51) Int. Cl. B07C 5/00

(52) U.S. Cl. 209/584

(57) ABSTRACT

An apparatus and method for sorting product. The apparatus comprises at least one unload module and at least two sorters. A matrix system is configured to receive product from the at least one unload module and divert the product to either of the at least two sorters via a plurality of divert units in a transportation path with the at least two sorters. A recirculating conveyor may also be provided which is configured to receive product from an unload module and divert the product to either of the at least two sorters. The recirculating conveyor may also be coupled to the matrix system.

### FIELD OF THE INVENTION

The invention generally relates to a sorting system and method of use and, more particularly, to an integrated system and method for sorting product using multiple sorters.

### BACKGROUND DESCRIPTION

The sorting of mail is a very complex, time-consuming task. In general, the sorting of mail is processed through many stages, including back end processes, which sort or sequence the mail in delivery order sequence. These processes can either be manual or automated, depending on the mail sorting facility, the type of mail being sorted such as packages, flats, letters and the like. A host of other factors may also contribute to the automation of the mail sorting, from budgetary concerns to modernization initiatives to access to appropriate technologies to a host of other factors.

In general, however, most modern facilities have taken major steps toward automation by the implementation of a number of technologies. These technologies include, amongst others, letter sorters, parcel sorters, advanced container conveyors, flat sorters and the like. As a result of these developments, postal and other types of handling facilities have become quite automated over the years, considerably reducing overhead costs.

Although known automated systems have provided many benefits, there are still improvements that can be made in order to minimize costs and maximize efficiencies. For example, current sorting systems are limited in their sorting speed, abilities and flexibility by their current designs. This is due to the fact that multiple sorters may not be efficiently integrated with one another, thus reducing overall throughput of the system.

For instance, in currently known attempts to the solve the problem of integrating several sorters with one another, feeders or unload modules are tied to individual sorters, limiting the discharge opportunities and thus the throughput of the system. In these known configurations, though, the sorters are tied together, for transfer of product from one sorter to another sorter. Thus, in these attempts, if a feeder is attempting to reach a sorter which is not directly attached to that feeder, the product must first be inducted onto a sorter connected with the feeder, and then the product must be transferred from the sorter to the destination sorter (final sorter). Although such configuration ultimately allows product to be fed from one feeder to any sorter, the system does not maximize the efficiencies of the feeders or sorters.

The invention is designed to overcome one or more of the above problems.

### SUMMARY OF THE INVENTION

In a first aspect of the invention, an apparatus an apparatus including a plurality of sorters and a plurality of unload modules having output conveyors. A matrix system has a plurality of transportation paths corresponding in number to the output conveyors which are to direct product to the plurality of sorters. The matrix system is configured to respectively receive product from the plurality of unload modules and divert the product to any of the plurality of sorters via a plurality of induction units in a transportation path with the plurality of sorters.

In another aspect of the invention, a system for sorting product includes at least two sorters, including a first sorter and a second sorter. A plurality of unload modules is provided which have a throughput which does not exceed the sorting capacity of the at least two sorters. A plurality of transportation paths are coupled between the plurality of unload modules at the at least two sorters. A plurality of induction units are configured to divert product from each of the plurality of transportation paths to any of the at least two sorters. A controller is configurable, based on product information of the product, to coordinate the induction of the product, originating from any of the plurality of unload modules, onto the first sorter from any of the plurality of transportation paths. The controller is further configurable to coordinate the induction of the product, originating from any of the plurality of unload modules, onto the second sorter from any of the plurality of transportation paths.

In another aspect of the invention, a method of sorting mail using a plurality of sorters includes obtaining product information from mail pieces and inducting the mail pieces onto one of several transportation paths. The method further includes determining whether the mail pieces should be inducted onto a first of a plurality of sorters, for sequencing or sorting to another depth level, and providing at least one of:
if the determining step is affirmative, inducting the mail pieces onto the first of the plurality of sorters for the sequencing or sorting to another depth level; and
if the determining step is negative, transporting the product past an induction or diverting location of the first of the plurality of sorters.

The method further includes determining whether the mail pieces should be inducted onto an immediately adjacent downstream sorter of the plurality of sorters, for sequencing or sorting to another depth level. The method further provides at least one of:
if the determining step is affirmative, inducting the mail pieces onto the immediately adjacent downstream sorter of the plurality of sorters for the sequencing or sorting to another depth level;
if the determining step is negative, transporting the product past an induction or diverting location of the immediately adjacent downstream sorter of the plurality of sorters; and
repeating the determining whether the mail pieces should be inducted onto an immediately adjacent downstream sorter of the plurality of sorters, for sequencing or sorting to another depth level and all subsequent steps until no more product cannot be inducted onto any of the plurality sorters.

### BRIEF DESCRIPTION OF THE DRAWINGS

FIG. 1 shows module components used in accordance with the invention; and

FIG. 2 shows a top view of a fully integrated system in accordance with the invention.

### DETAILED DESCRIPTION OF EMBODIMENTS OF THE INVENTION

The invention is directed to an integrated system and method of use configured to sort product inducted from any combination of unload modules (e.g., feeders) directly to any number of sorters. The product may be, for example, flats, parcels, packages and other mail items (i.e., letters), baggage, etc. for future delivery or warehousing or the like. The invention significantly reduces machine costs by reducing material handling equipment, while improving overall throughput of multiple sorters. The system of the invention is modular, in nature, and can be implemented across different machines, over several machines and, in embodiments, can be easily retrofitted to add sorters to a preexisting machine configuration. Other applications such as warehousing and storage applications are also contemplated for use with the invention.

In one aspect of the invention, several sorters can be fed by one or more unload modules by use of interconnecting conveyors to permit product delivery from multiple locations. By use of the invention, as discussed in greater detail below, sorters can be fed from one or more unload modules, independently, with multiple induction and discharge units to achieve increased throughput. In addition, by using the system of the invention, induction and discharge units can be placed in multiple locations on the sorters, thus significantly reducing the length of interconnecting conveyor runs, saving valuable flooring space.

### Modular Components of the Invention

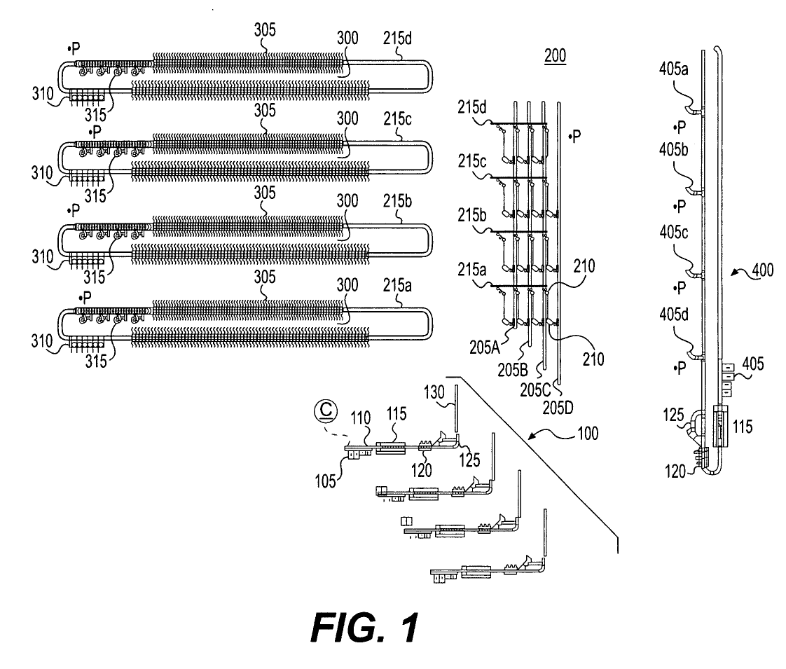

Referring now to FIG. 1, components in accordance with the invention are shown. The components and accompanying machinery, etc. are modular, capable of being interconnected to existing sorters and the like. The mechanical components and accompanying machinery, etc. are well known in the field of integrated sorting and sequencing systems such as those sold and/or manufactured by Lockheed Martin Corporation. Accordingly, a detailed explanation of each of the mechanical components is not required for one of skill in the art to understand and practice the invention. Instead, the description herein provides an overview of the description of the components and accompanying machinery, etc., and focuses on a detailed description of the integration and use of the components and accompanying machinery, conveyors, etc, to enable one of skill to practice the integrated system and method of the invention.

It should be understood by those of skill in the art that the components discussed herein such as, for example, the transportation paths, as well as any of the induction units, conveyors, etc, can be separate components, which are integrated together during the assembly process. In alternative embodiments, some or all of these components may be integrated components, prior to the assembly of the integrated system such as, for example, an induction unit associated with a sorter, as one non-limiting example. In either situation, the fully assembled system is an integrated system with the constituent components described herein. Thus, the description herein should not be limited to any of the components being initially integrated or separated.

Unload Module

FIG. 1 shows several unload modules generally at reference numeral 100, each of which includes one or more unloading stations 105. In the embodiment of FIG. 1, four unload modules are shown; however, the invention is not limited to a specific amount of unload modules. In implementation, though, the capacity of the unload modules should correspond with the capacity of a number of sorters. In one known configuration, the unload modules may have a capacity of approximately 5,000 product per hour.

In the embodiment of FIG. 1, four unloading stations 105 are shown; however, more or less than four unloading stations 105 can be used with the overall system, depending on the desired configuration. In one non-limiting illustrative aspect of the invention, the unloading stations 105 may be a lift and tilt mechanism, which lifts product to a desired conveyor height, and unloads the product onto a conveyor 110 of the unload module 100.

The unload modules 100 further include a singulator unit 115 in the transportation path of the conveyor 110. The singulator unit 115 singulates the incoming product into a stream of product, which is transported to an imaging unit 120. The imaging unit 120, may be bar code scanners or optical reader scanners, etc., which will obtain product information from the product and provide such information to a control “C”, via a network or other type of communication path. The controller “C” will reconcile the product information for future sorting and/or sequencing, in a well-known manner. The controller “C” may also be in communication with many of the other sub-systems of the invention, as needed.

A divert station 125 is also associated with each of the unload modules 100. The divert station 125 diverts product which werwe not read by the imaging unit 120. At the divert station 125, entry of the product information may be manually keyed at a central location, or a video coding system may record the information and provide it to a remote location for keying. Once the product information is obtained from either of the divert station 125 or the imaging equipment 120, the product can then be inducted onto a conveyor 130.

Matrix System

FIG. 1 further shows a matrix system 200 comprising a plurality of interconnected transportation paths 205a-205d (e.g., belt conveyors, rollers, etc.). The transportation paths 205a-205d may be connected and/or coupled to a respective conveyor 130 of each unload module 100. Accordingly, the number of the interconnected transportation paths 205a-205d should be equal to the number of conveyors 130 or unload modules 100, in one example.

The matrix system 200 includes induction or divert units 210 configured to allow induction of product from each of the transportation paths 205a-205d to a common induction zone 215a-215d, respectively, associated with each of the transportation paths 205a-205d. In an alternative embodiment, the transportation paths 205a-205d and induction zones 215a-215d may be integrated into a sorter. In use, product traveling along the matrix system 200 can be diverted to any sorter from any unload module by way of the induction or divert units 210.

Sorter

FIG. 1 shows several (e.g., four) sorters 300, which may be any conventional-type sorter, with a plurality of discharge or bin locations 305. In one embodiment, the sorters 300 include 360 bin locations 305; although, other amounts of bin locations (and sorters) are also contemplated for use with the invention. The sorters also include output chutes or discharge points 310. The sorters 300 may be configured into a loop configuration and, in the example of FIG. 1, may each have a sorting and/or sequencing capacity of 10,000 product per hour; although other capacities are equally contemplated for use with the invention.

The sorters 300, in one aspect of the invention, are connected to the matrix system 200, at the respective induction zones 215a-215d. In an alternative embodiment, the transportation paths 205a-205d may be integrated into the sorters 300 at the induction zones 215a-215d such that the matrix system 200 is connected thereto.

Without departing from the invention, induction or divert units 315 may be coupled directly to each of the sorters 300, and configured to allow induction of product from each of the transportation paths 205a-205d of a respective matrix systems 200, in addition to other components (e.g., recirculating conveyor 400). The induction or divert units 315 may be located downstream from the induction zones 215a-215d.

Recirculating Conveyor

FIG. 1 further shows a recirculating conveyor 400. The recirculating conveyor 400, in one embodiment, comprises a flat belt configuration; however, the recirculating conveyor 400 can comprise rollers or other transport systems, as another example. The recirculating conveyor 400 further includes a plurality induction or divert units 405a-405d, which are designed to induct product onto different sorters 300. Accordingly, in one embodiment, the induction or divert units 405a-405d may equal the number of sorters, and in one specific embodiment, may be four induction units positioned on one side of a loop configuration.

In one non-limiting illustration, the recirculating conveyor 400 also includes an unload module 100. Much like that discussed above, the unload module 100 includes (i) one or more unloading stations 105, (ii) a singulator unit 115 in the transportation path of the conveyor 110, (iii) an imaging unit 120 and (iv) a divert station 125. The recirculating conveyor 400 can rotate either in the clockwise or counter-clockwise direction.

Sensors

Sensors such as photodiodes and/or encoders can be used to maintain track of the product throughout the entire integrated system, as generally represented at “P”. It should be understood that the sensors “P” may be several sensors, as discussed below.

In one example, product may be inducted onto the matrix system 200 from any of the unload modules, at which time it will pass through (interrupts) a light beam of the photodiode. Using an encoder, and knowing that the product just interrupted a beam of the photodiode, the controller can determine the particular location of a particular product within the integrated system, in a well-known manner. This same or similar procedure can be used at any induction or divert point on the matrix system 200 and/or the recirculating conveyor 400 to determine the location of any product within the system and, which product is to be diverted onto the sorter, based on the reconciled information and under coordination of the controller C″.

### Integrated System of the Invention

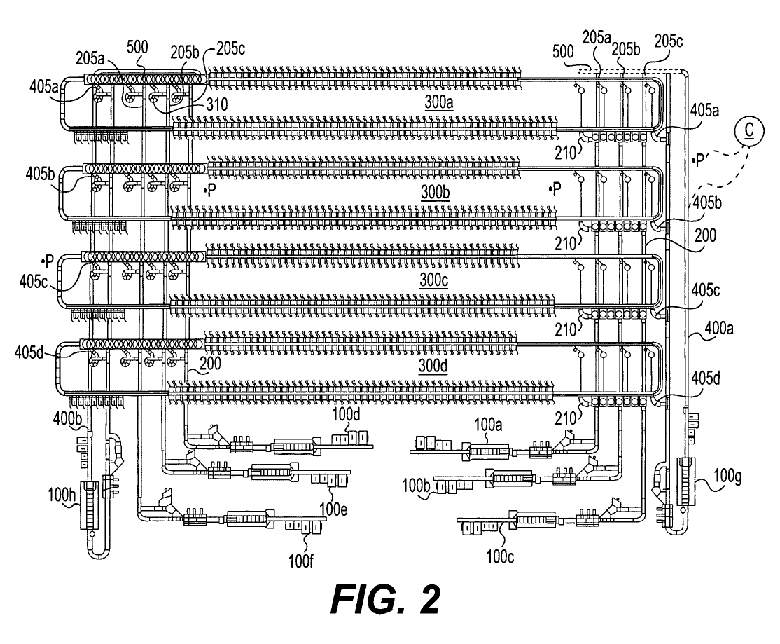

FIG. 2 shows a top view of an exemplary integrated system in accordance with the invention. In FIG. 2, unload modules 100a, 100b, 100c, 100d, 100e and 100f are coupled to four sorters 300a, 300b, 300c and 300d by the matrix system 200. More specifically, the unload modules 100a, 100b, 100c, 100d, 100e and 100f are coupled to the four sorters 300a-300d at the induction zones 215a-215d, respectively, by the induction or divert units 210. In the embodiment of FIG. 2, each of the matrix systems includes three transportation paths 205a, 205b, and 205c, one associated with each of the unload modules 100a-100f. Photodiodes or other sensors may be positioned at the entry of each transportation path 205a-205c and each induction or divert unit 210 (in addition to divert units 315 and divert units 405a-405d of induction units 400a, 400b).

Still referring to FIG. 2, the unload modules each include a singulator and an imaging unit. As product is inducted into the unload module, the product will be singulated by the singulator unit 115 of each of the unload modules, and product information will be obtained by the imaging unit 120. The product can also be scanned for address/ZIP code, sized, weighed and typed by the imaging unit and related components, such as a weight sensor (also shown as reference numeral 120).

In the embodiment of FIG. 2, after the product information is obtained, the product information will be provided to the controller “C”, via a network or other type of communication path. The resolved information is used to direct the product from any given infeed, e.g., unload module, to the appropriate sorter 300a-300b. In one embodiment, the sorters 300a-300d may be configured into a loop, and each includes 360 bin locations.

As a non-limiting example, the throughput of the combined sorters 300a-300d may be approximately 40,000 pieces of product per hour and the output of each of the unload modules may be approximately 5,000 pieces per hour. Hence, using the configuration of FIG. 2, the total output of the eight unload modules is approximately 40,000 pieces per hour, which is equal to the capacity of the sorters 300a-300d. It should be understood, though, that other combinations of more or less sorters and unload modules may be used with the different outputs system, depending on the configured throughput of the system.

FIG. 2 further shows two of the recirculating conveyers 400a, 400b, each with an additional unload module 100g, 100h. The recirculating conveyers 400a, 400b are coupled to the sorters 300a-300d, via the induction units 310, in addition to being coupled to each of the transportation paths 205a, 205b, and 205c by a conveyance 500. The conveyance 500 may be used, in one example, to recirculate product inducted from any of the unload modules 100a-100f.

As shown in the configuration of FIG. 2, the recirculating conveyers 400a, 400b are connected to opposing ends of the sorters, outside of the matrix system 200. In the embodiment of FIG. 2, the recirculating conveyer 400a rotates clockwise, whereas, the recirculating conveyor 400b rotates counterclockwise.

### Method of Use

Still referring to FIG. 2, product will be inducted onto any of the unload modules for transport to any of the sorters, for sorting or sequencing. At this stage, the product will be singulated, and information will be obtained by the imaging unit. If information cannot be obtained, it can be manually entered into the system. The information will then be reconciled by the controller for diversion of the product to a particular sorter.

In a stage of operation, the product will be inducted onto the transportation paths of the matrix system for induction onto any of the sorters. In other embodiments, the product may also be inducted onto one of the recirculating conveyors, from either of the respective unload modules 100g, 100h. As the product is inducted onto the transportation paths of the matrix system or the recirculating conveyor, it will pass through (interrupts) a light beam of the photodiode, or activate any number of other types of sensors, e.g., weight sensor, etc.

Once the product has been inducted and detected, an encoder can be used to determine the exact location of the particular product on any of the transportation paths and/or the recirculating conveyor. For example, using an encoder, and knowing that the product just interrupted a beam of the photodiode (or activate any number of other types of sensors, e.g., weight sensor, etc.), the controller can determine the particular location of a particular product within the integrated system.

As the product reaches any of the divert units, it again will pass through or activate a sensor located near the divert unit. If the product is to inducted at that divert unit, for a particular sorter, the divert unit will be activated so as to divert that product onto the particular sorter. The sorter can then sort or sequence the product, in a well-known manner. If any product is not initially inducted onto the sorter, from any transportation path of the matrix system, it can flow to the respective recirculating conveyor and be inducted during another pass, but now using the recirculating conveyor.

Exemplary Method of Use

In one illustrative non-limiting example, using eight destination locations, the following conditions are contemplated:
product for destinations 1-8 are randomly loaded onto the unload modules 100a-100h;
product for destinations 1, 2 are to be inducted onto sorter 300a;
product for destinations 3, 4 are to be inducted onto sorter 300b;
product for destinations 5, 6 are to be inducted onto sorter 300c; and
product for destinations 7, 8 are to be inducted onto sorter 300d.

After each product is loaded onto the unload module, it will be singulated and information obtained therefrom. The product information, in this example, will include the destination information of the product. This information will then be passed to the controller, which will then reconcile such information, e.g., instruct the system which product has to go to which sorter. In this example above, product from any of the unload modules, will be directed as follows:
product for destinations 1, 2 are reconciled to be inducted onto sorter 300a;
product for destinations 3, 4 are reconciled to be inducted onto sorter 300b;
product for destinations 5, 6 are reconciled to be inducted onto sorter 300c; and
product for destinations 7, 8 are reconciled to be inducted onto sorter 300d.

After product information is obtained, each product will be inducted onto each respective transportation path associated with the unload module. Once the product is inducted onto any transportation path of the matrix system or the recirculating conveyors, the product can be tracked throughout the entire system using, for example, a combination of sensors, encoders, or the like, and diverted to the appropriate sorter. By way of illustration, knowing the induction point and time of the product into the integrated system:
as any product for destinations 1, 2 pass the sensor for the divert unit of sorter 300a, the sensor will sense such product, active the divert unit, and the divert unit will divert the product onto the sorter 300a
as any product for destinations 3, 4 pass the sensor for the divert unit of sorter 300b, the sensor will sense such product, active the divert unit, and the divert unit will divert the product onto the sorter 300b;
as any product for destinations 5, 6 pass the sensor for the divert unit of sorter 300c, the sensor will sense such product, active the divert unit, and the divert unit will divert the product onto the sorter 300c; and
as any product for destinations 7, 8 pass the sensor for the divert unit of sorter 300d, the sensor will sense such product, active the divert unit, and the divert unit will divert the product onto the sorter 300d.

Any product which is not diverted onto a sorter may be recirculated to the recirculating conveyors. For example, in the configuration of FIG. 2, any product initially inducted from unload modules 100a-100c and 100g can be recirculated by the recirculating conveyer 400a Similarly, any product initially inducted from unload modules 100d-100f and 100h can be recirculated by the recirculating conveyer 400b.

While the invention has been described in terms of embodiments, those skilled in the art will recognize that the invention can be practiced with modification within the spirit and scope of the appended claims.

What is claimed is:

1. An apparatus, comprising:
a plurality of sorters;
a plurality of unload modules having output conveyors;
a matrix system having a plurality of transportation paths corresponding in number to the output conveyors which are to direct product to the plurality of sorters, the matrix system configured to respectively receive product from the plurality of unload modules and divert the product to any of the plurality of sorters via a plurality of induction units in a transportation path with the plurality of sorters.

2. The apparatus of claim 1, further comprising a recirculating conveyor including a plurality of divert units at least corresponding to a number of the plurality of sorters and configured to divert product from the recirculating conveyor to any of the plurality of sorters.

3. The apparatus of claim 2, wherein the transportation paths of the matrix system are coupled to the recirculating conveyor, the recirculating conveyor being configured to recirculate product to any of the plurality of sorters, which were not initially inducted from the transportation paths.

4. The apparatus of claim 2, further comprising a second recirculating conveyor including a plurality of divert units and configured to divert product from the recirculating conveyor to any of the plurality of sorters.

5. The apparatus of claim 1, wherein an output of the plurality of unload modules does not exceed a throughput of the plurality of sorters.

6. The apparatus of claim 1, wherein:
the plurality of sorters are at least three sorters, including a first sorter, a second sorter and a third sorter; and
the plurality of transportation paths are coupled to the at least three sorters and configured to divert product from each of the plurality of unload modules to any of the first, second or third sorters at diversion zones.

7. The apparatus of claim 6, wherein:
a first group of the induction units are common to the transportation paths and the first sorter;
a second group of the induction units are common to the transportation paths and the second sorter; and
a third group of the induction units are common to the transportation paths and the third sorter.

8. The apparatus of claim 1, further comprising a controller which is configurable to coordinate discharge of the product from any of the plurality of transportation paths to any of the plurality of sorters.

9. The apparatus of claim 1, further comprising a first plurality of sensors positioned near an entrance section of the plurality of transportation paths and a second plurality of sensors positioned prior to each of the induction units which divert the product to each of the plurality of sorters.

10. The apparatus of claim 9, further comprising a controller which is configurable to:
receive signals from the sensors about product movement as the product enters the plurality of transportation paths and prior to the induction units; and
coordinate the product movement based on obtained product information to induct the product into one of the induction units for diversion into an appropriate sorter of the plurality of sorters.

11. The apparatus of claim 1, wherein the product is mail.

12. The apparatus of claim 1, further comprising a recirculating conveyor connected to each of the plurality of transportation paths and associated with at least one additional unload mechanism, the recirculating conveyor configured to receive product from each of the transportation paths and recirculate the received product to any of the plurality of sorters.

13. The apparatus of claim 1, wherein the induction units include a first group of induction units coupled to a downstream side of bin locations of each of the plurality of sorters and a second group of the induction units coupled to an upstream side of the bin locations of each of the plurality of sorters.

14. The apparatus of claim 13, wherein the plurality of unload modules include a first group positioned on a first side and associated with the first group of induction units and a second group positioned on a second side and associated with the second group of induction units, the unload modules providing the product to the first and second group of induction units via the plurality of transportation paths.

15. A system for sorting product, comprising:
at least two sorters, including a first sorter and a second sorter;
a plurality of unload modules which have a throughput which does not exceed the sorting capacity of the at least two sorters;
a plurality of transportation paths coupled between the plurality of unload modules at the at least two sorters;
a plurality of induction units configured to divert product from each of the plurality of transportation paths to any of the at least two sorters; and
a controller which is configurable, based on product information of the product, to coordinate:
the induction of the product, originating from any of the plurality of unload modules, onto the first sorter from any of the plurality of transportation paths; and
the induction of the product, originating from any of the plurality of unload modules, onto the second sorter from any of the plurality of transportation paths.

16. The system of claim 15, wherein the product are mail pieces.

17. The system of claim 15, further comprising a recirculating conveyor connectable between each of the plurality of transportation paths and associated with at least one additional unload mechanism, the recirculating conveyor configured to receive product from each of the plurality of transportation paths to any of the at least two sorters and to divert the received product to any of the at least two sorters.

18. The system of claim 17, wherein the recirculating line is configured in a loop.

19. The system of claim 15, further comprising at least one sensor to determine a position of the product as it enters each of the transportation paths and nears any of the plurality of induction units, the at least one sensor coupled with the controller to provide signals thereto and, based on the signals, the controller configured to coordinate the induction of the product onto one of the at least two sorters.

20. The system of claim 15, wherein each of the at least two sorters are configured in a loop.

21. The system of claim 15, wherein the plurality of induction units include a first group of induction units coupled to a downstream side of bin locations of each of the at least two sorters and a second group of the induction units coupled to an upstream side of the bin locations of each of the at least two of sorters.

22. The apparatus of claim 21, wherein the plurality of unload modules include a first group positioned on a first side and associated with the first group of induction units and a second group positioned on a second side and associated with the second group of induction units, the unload modules providing the product to the first and second group of induction units via the plurality of transportation paths.

23. A method of sorting mail using a plurality of sorters, comprising:
obtaining product information from mail pieces;
inducting the mail pieces onto one of several transportation paths;
determining whether the mail pieces should be inducted onto a first of a plurality of sorters, for sequencing or sorting to another depth level; and
providing at least one of:
if the determining step is affirmative, inducting the mail pieces onto the first of the plurality of sorters for the sequencing or sorting to another depth level;
if the determining step is negative, transporting the product past an induction or diverting location of the first of the plurality of sorters; and
determining whether the mail pieces should be inducted onto an immediately adjacent downstream sorter of the plurality of sorters, for sequencing or sorting to another depth level; and
providing at least one of:
if the determining step is affirmative, inducting the mail pieces onto the immediately adjacent downstream sorter of the plurality of sorters for the sequencing or sorting to another depth level;
if the determining step is negative, transporting the product past an induction or diverting location of the immediately adjacent downstream sorter of the plurality of sorters; and
repeating the determining whether the mail pieces should be inducted onto an immediately adjacent downstream sorter of the plurality of sorters, for sequencing or sorting to another depth level and all subsequent steps until no more product cannot be inducted onto any of the plurality sorters.

24. The method of claim 23, wherein the product information includes at least one of destination information and location of the product.

25. The method of claim 24, further comprising recirculating product which was not inducted onto any of the plurality of sorters back to the plurality of sorters.
